(19) United States
(12) Patent Application Publication
(10) Pub. No.: US 2026/0208036 A1
(43) Pub. Date: Jul. 23, 2026

(54) GAMEPAD FOR ELECTRONIC DEVICE

(71) Applicant: SHENZHEN SAITAKE ELECTRONIC CO., LTD, Shenzhen (CN)

(72) Inventor: Siming GUO, Shantou (CN)

(21) Appl. No.: 19/568,967

(22) Filed: Mar. 17, 2026

(30) Foreign Application Priority Data
Feb. 9, 2026 (CN) 202610186096.8

(51) Int. Cl. A63F 13/24

(52) U.S. Cl. CPC A63F 13/24

(57) ABSTRACT

A gamepad for an electronic device is provided, including a gamepad housing, a control assembly, and a clamping assembly. The clamping assembly includes a clamping base, a clamping link, and a clamping frame. The clamping base is fixedly arranged on the gamepad housing. One end of the clamping link is rotatably connected to the clamping base, and another end of the clamping link is rotatably connected to the clamping frame. The clamping frame is fixedly provided with a permanent magnet. The permanent magnet is configured to magnetically fix the electronic device. The clamping assembly has an unfolded state and a folded state. The present disclosure has an effect of enabling a user to better adjust a watching position and a watching angle of the electronic device.

### CROSS-REFERENCE TO RELATED APPLICATIONS

This application claims priority to Chinese Patent Application No. 202610186096.8, filed on Feb. 9, 2026, which is hereby incorporated by reference in its entirety.

### TECHNICAL FIELD

The present disclosure relates to the field of gamepads, and in particular, to a gamepad for an electronic device.

### BACKGROUND

Electronic devices have been widely used in the field of e-sports. Some game developers have launched exclusive games suitable for various electronic devices such as smart phones and tablet computers. However, control methods relying on touch screens or built-in buttons of the electronic devices have limitations in adaptation, so that it is hard to support high-efficiency e-sports operations, and this poses challenges to a competitive experience and a competition effect. To meet this demand, a gamepad capable of achieving wireless or wired communication with the electronic devices have emerged.

At present, the gamepad generally includes a gamepad housing, a control assembly, and a clamping plate. The control assembly is disposed on the gamepad housing and is configured to control e-sports games. One end of the clamping plate is rotatably connected to the gamepad housing, and the clamping plate is provided with a gripping claw for clamping and fixing an electronic device, to ensure a good e-sports game experience for users.

For the foregoing relevant technology, after clamping the electronic device, the existing clamping plate can only drive the electronic device to rotate around one rotation axis to adjust an observation angle of the electronic device. As a result, the adjustability of a distance and angle between the electronic device and the gamepad housing is poor. Consequently, a user cannot adjust the electronic device to a proper watching position and angle, and the user experience is poor.

### SUMMARY

To make a user better adjust a watching position and a watching angle of an electronic device, the present disclosure provides a gamepad for an electronic device.

The gamepad for the electronic device provided in the present disclosure uses the following technical solution:

A gamepad for an electronic device includes a gamepad housing, a control assembly, and a clamping assembly. The gamepad housing is divided into a left functional region, a middle functional region, and a right functional region. The left functional region is connected to one end of the middle functional region, and the right functional region is connected to another end of the middle functional region. The control assembly is arranged on the housing and is configured to control an e-sports game.

The clamping assembly includes a clamping base, a clamping link, and a clamping frame. The clamping base is fixedly arranged in the middle functional region. One end of the clamping link is rotatably connected to the clamping base, and another end of the clamping link is rotatably connected to the clamping frame, to achieve unfolding and folding of the clamping assembly. The clamping frame is fixedly provided with a permanent magnet. The permanent magnet is configured to magnetically fix the electronic device. When the clamping assembly is in a folded state, the clamping link and the clamping frame are both in abutting fit with the middle functional region. When the clamping assembly switches from the folded state to an unfolded state, at least one of the clamping link and the clamping frame rotates relative to the clamping base.

Optionally, a placement slot is formed in the middle functional region; and when the clamping assembly is in the folded state, the clamping frame is located in the placement slot.

Optionally, an abutment groove is formed in the middle functional region, and the abutment groove is configured to be in abutting fit with the clamping link and support the clamping link.

Optionally, the control assembly includes a control circuit board, a game control input module, and a battery module. The control circuit board is fixedly disposed within the gamepad housing. The game control input module is fixed and electrically connected to the control circuit board. The battery module is arranged on the gamepad housing and is electrically connected to the control circuit board.

Optionally, the gamepad housing is fixedly provided with a joystick bracket. The joystick bracket presses and fixes the control circuit board to the gamepad housing.

Optionally, the gamepad housing is provided with a battery compartment. A compartment body of the battery compartment is detachably connected with a battery cover for closing the battery compartment. The battery module is mounted in the battery compartment.

Optionally, the battery module is fixedly disposed within the gamepad housing.

Optionally, the control circuit board is fixed and electrically connected to a lighting indicator and a universal serial bus (USB) charging module, to charge and display the battery module.

In summary, the present disclosure include at least one of the following beneficial effects:

When a user needs to control an e-sports game by using the gamepad, the clamping link rotates relative to the clamping base, and the clamping frame rotates relative to the clamping link, so that the clamping assembly switches from the folded state to the unfolded state. After the clamping frame is unfolded to an appropriate position, the electronic device is fixed to the clamping frame by magnetic attraction of the permanent magnet, making it convenient for the user to observe the electronic device. After the electronic device is clamped and fixed by the clamping frame, a distance and angle between the electronic device and the gamepad housing can be continued to be adjusted through the relative rotation between the clamping link and the clamping base, and the relative rotation between the clamping frame and the clamping link, thereby adjusting the electronic device to an appropriate watching position and angle. This mitigates the following problems: After clamping the electronic device, the existing clamping plate can only drive the electronic device to rotate around one rotation axis to adjust an observation angle of the electronic device. As a result, the adjustability of a distance and angle between the electronic device and the gamepad housing is poor. Consequently, a user cannot adjust the electronic device to a proper watching position and angle, and the user experience is poor.

### BRIEF DESCRIPTION OF THE DRAWINGS

FIG. 1 is a schematic diagram of an entire structure according to the present disclosure;

FIG. 2 is a schematic diagram of a folded state of an entire structure according to the present disclosure;

FIG. 3 is a first schematic diagram of an unfolded state of an entire structure according to the present disclosure;

FIG. 4 is a second schematic diagram of an unfolded state of an entire structure according to the present disclosure;

FIG. 5 is a third schematic diagram of an unfolded state of an entire structure according to the present disclosure;

FIG. 6 is a first schematic diagram of a structure of a control assembly according to an embodiment of the present disclosure;

FIG. 7 is a second schematic diagram of a structure of a control assembly according to an embodiment of the present disclosure;

FIG. 8 is a schematic diagram of a structure of a battery compartment according to an embodiment of the present disclosure;

FIG. 9 is a first schematic diagram of a usage state according to an embodiment of the present disclosure;

FIG. 10 is a second schematic diagram of a usage state according to an embodiment of the present disclosure; and

FIG. 11 is a third schematic diagram of a usage state according to an embodiment of the present disclosure.

Reference numerals in the accompanying drawings: 1: gamepad housing; 1 a: left functional region; 1b: middle functional region; 1b1: placement slot; 1b2: abutment groove; 1 c: right functional region; 11: joystick bracket; 12: battery compartment; 121: battery cover; 13: top shell; 14: bottom shell; 2: control assembly; 21: control circuit board; 211: lighting indicator; 212: USB charging module; 22: game control input module; 22a: lever; 22b: control button; 22c: trigger; 22d: power button; 22e: program button; 23: battery module; 3: clamping assembly; 31: clamping base; 32: clamping link; 33: clamping frame; 331: permanent magnet; 10: gamepad; and 20: electronic device.

### DETAILED DESCRIPTION OF THE EMBODIMENTS

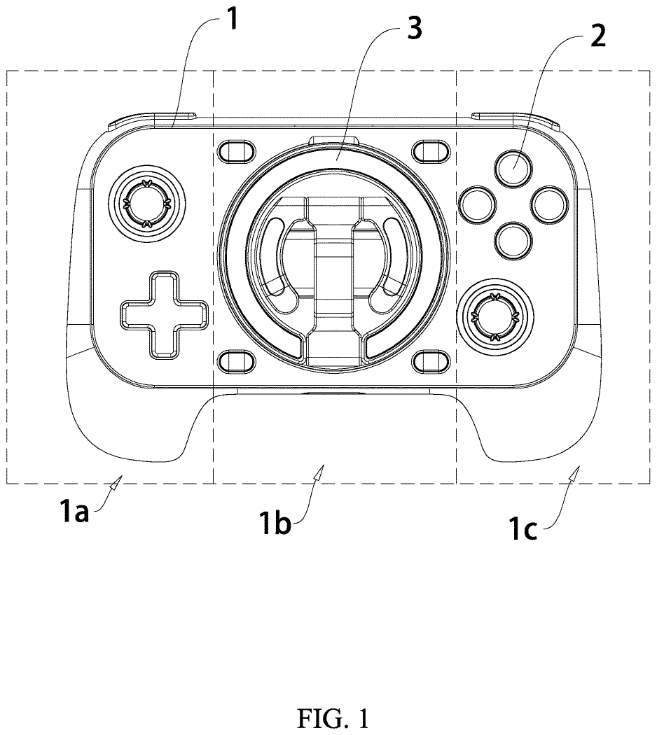

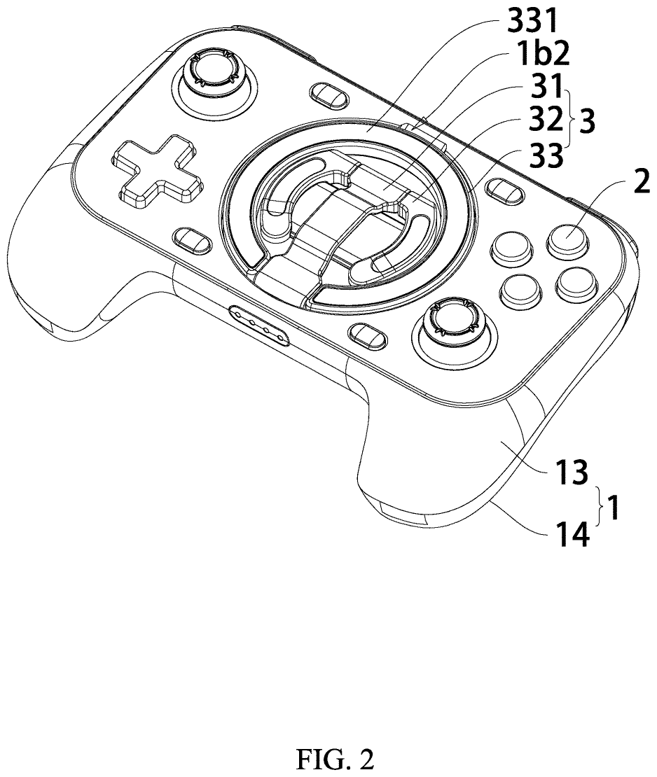

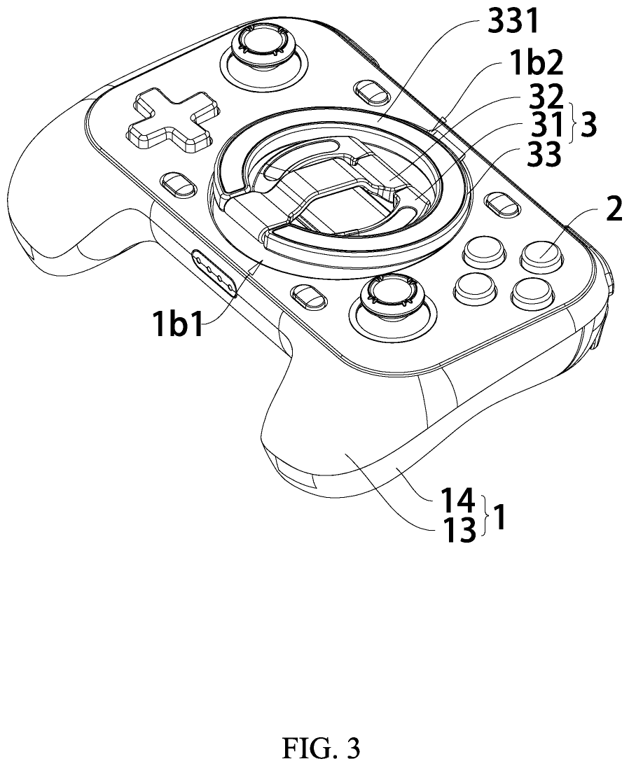

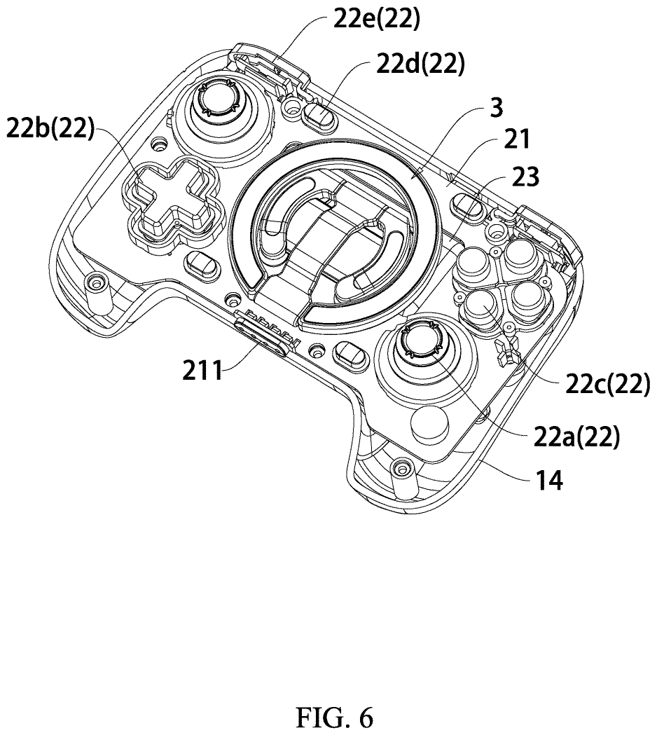

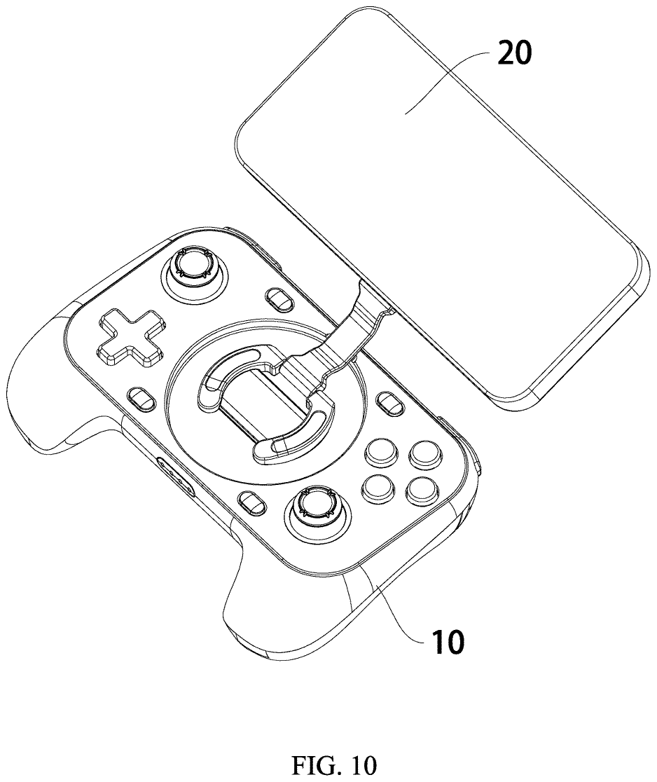

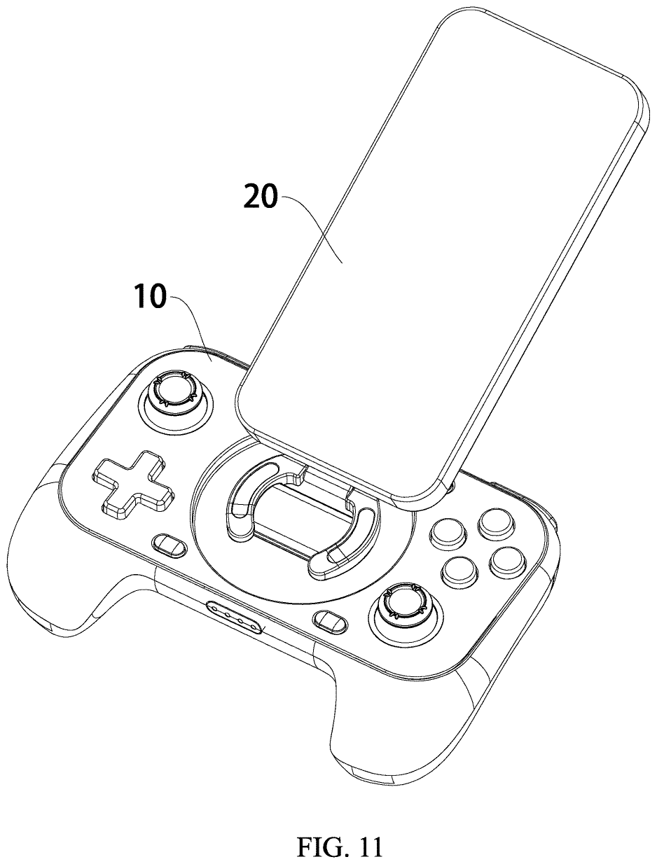

The present disclosure will be further described in detail below in conjunction with FIG. 1 to FIG. 11.

An embodiment of the present disclosure discloses a gamepad for an electronic device. Referring to FIG. 1 to FIG. 4, a gamepad 10 for an electronic device includes a gamepad housing 1, a control assembly 2, and a clamping assembly 3. The gamepad housing 1 is divided into a left functional region 1a, a middle functional region 1b, and a right functional region 1c. The left functional region 1a is connected to one end of the middle functional region 1b, and the right functional region 1c is connected to another end of the middle functional region 1b, so that it is convenient for a user to hold and use the gamepad housing 1. The control assembly 2 is arranged on the housing 1 and is configured to control an e-sports game. The clamping assembly 3 includes a clamping base 31, a clamping link 32, and a clamping frame 33. The clamping base 31 is fixedly arranged in the middle functional region 1b. One end of the clamping link 32 is rotatably connected to the clamping base 31, and another end of the clamping link 32 is rotatably connected to the clamping frame 33. Thus, unfolding and folding of the clamping assembly 3 can be achieved. The clamping frame 33 is fixedly provided with a permanent magnet 331. The permanent magnet 331 is configured to magnetically fix the electronic device 20. When the clamping assembly 3 is in a folded state, the clamping link 32 and the clamping frame 33 are both in abutting fit with the middle functional region 1b. When the clamping assembly 3 switches from the folded state to an unfolded state, at least one of the clamping link 32 and the clamping frame 33 rotates relative to the clamping base 31.

In this embodiment, the gamepad housing 1 includes a top shell 13 and a bottom shell 14. The top shell 13 and the bottom shell 14 are fixedly connected to each other through a screw to form the gamepad housing 1.

Referring to FIG. 1 to FIG. 4, in this embodiment of the present disclosure, the middle functional region 1b is provided with a placement slot 1b1. When the clamping assembly 3 is in the folded state, the clamping frame 33 is located in the placement slot 1b1, so that when the clamping assembly 3 is in the folded state, the clamping assembly 3 has less impact on the surface flatness of the middle functional region 1b, making it easier to use the gamepad 10 to control a game when the gamepad is connected to other game devices.

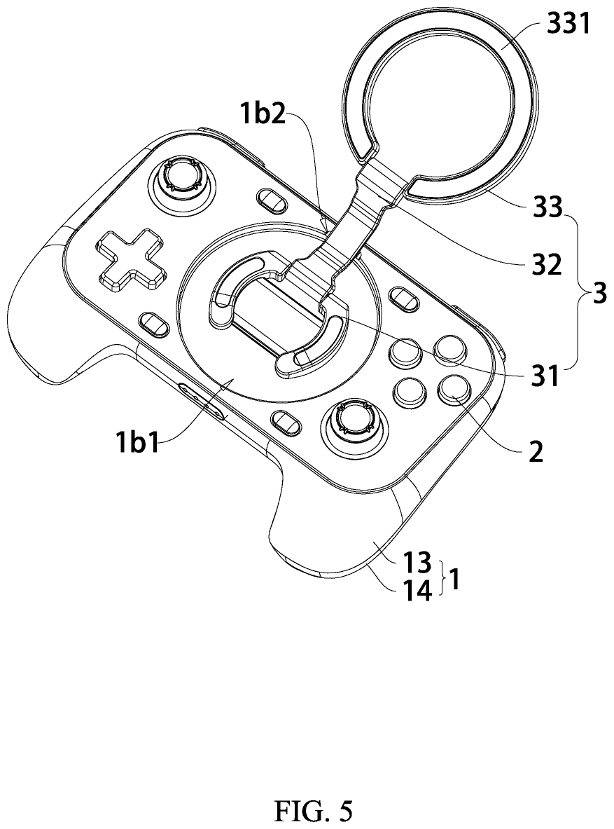

Referring to FIG. 5 to FIG. 7, in this embodiment of the present disclosure, the clamping assembly 3 further includes an activation link. A rotation hole is formed in the middle functional region 1b. The activation link passes through and is rotatably arranged in the rotation hole. When the activation link rotates, the activation link pushes the clamping frame 33 to rotate, thereby making the clamping assembly 3 switch from the folded state to the unfolded state, so that the clamping assembly 3 switches from the folded state to the unfolded state more easily and conveniently. In a further implementation, the activation link includes a first rotating end, a connecting section, and a second rotating end. The first rotating end is fixedly connected to one end of the connecting section, and the second rotating end is fixedly connected to another end of the connecting section. The first rotating end is located at a bottom of the clamping frame 33, and the second rotating end is located on one side of the middle functional region 1b. When the second rotating end is driven to rotate, the second rotating end drives the first rotating end to rotate and pushes the clamping frame 33 to rotate. In a further implementation, the clamping assembly 3 further includes a metal activation block. The metal activation block is fixedly arranged in the middle functional region 1b. The metal activation block is in abutting fit with the activation link, so that when the activation link rotates to push the clamping frame 33 to rotate, the metal activation block provides a supporting force and a reaction force for the activation link, thereby protecting the gamepad housing 1 from being damaged.

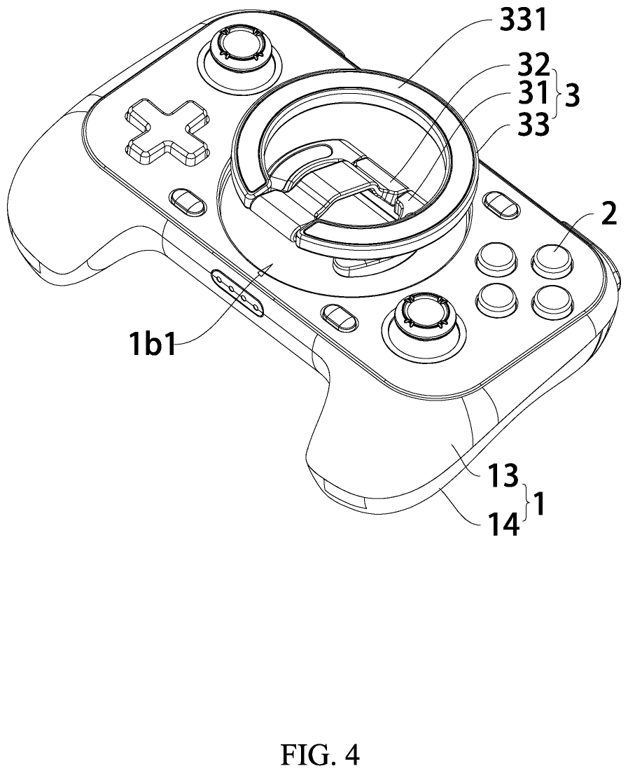

Referring to FIG. 4, in this embodiment of the present disclosure, the middle functional region 1b is provided with an abutment groove 1b2. The abutment groove 1b2 is configured to be in abutting fit with the clamping link 32 and support the clamping link 32. It can be understood that when the clamping link 32 rotates away from the clamping base 31 for unfolding, after the clamping link 32 rotates to a maximum angle, the clamping link 32 is in abutting fit with the abutment groove 1b2, so that the abutment groove 1b2 can support the clamping link 32. Thus, an angle between the clamping link 32 and the clamping base 31 can also be maintained stable when the electronic device 20 is magnetically fixed to the clamping frame 33.

It can be understood that the clamping link 32 can protrude towards one side and be in abutting fit with the abutment groove 1b2, so as to provide a clamping position confirm feedback and an angle limitation, making the overall shape more comfortable and stable.

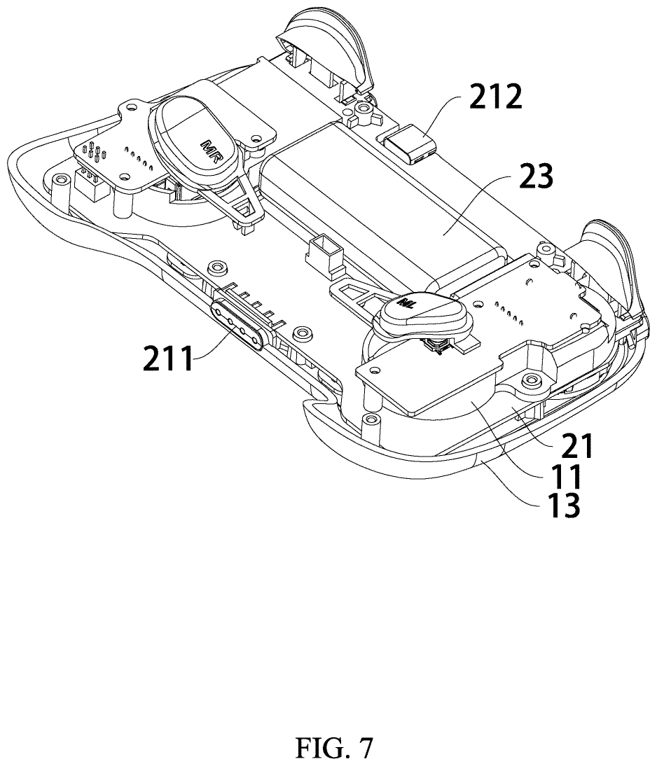

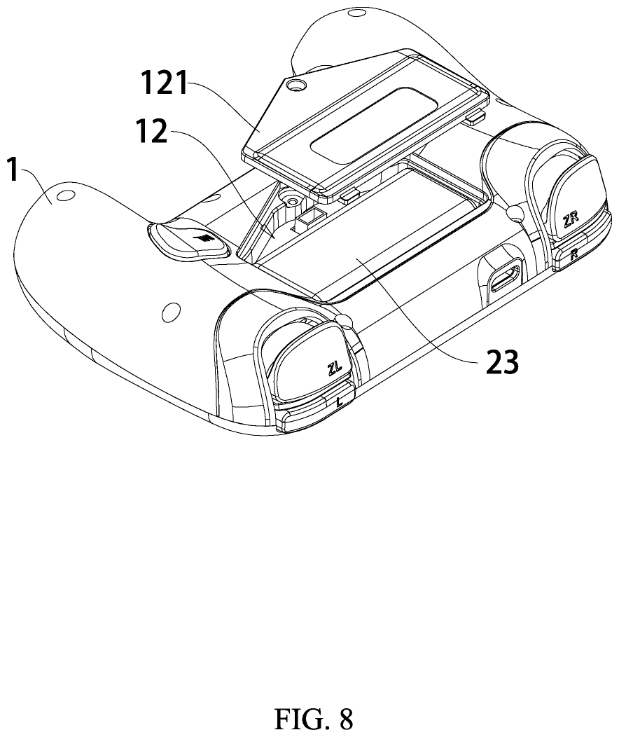

Referring to FIG. 7 and FIG. 8, in this embodiment of the present disclosure, the control assembly 2 includes a control circuit board 21, a game control input module 22, and a battery module 23. The control circuit board 21 is fixedly arranged on the gamepad housing 1. The game control input module 22 is fixedly and electrically connected to the control circuit board 21, and the battery module 23 is arranged on the gamepad housing 1 and is electrically connected to the control circuit board 21. It should be understood that a plurality of game control input modules 22 are included. Some game control input modules 22 are located in the left functional region 1a, some game control input modules 22 are located in the right functional region 1c, and the remaining game control input modules 22 are located in the middle functional region 1b. It can be understood that the game control input modules 22 can be a joystick 22a, a control button 22b, a trigger 22c, a power button 22d, and a program button 22e. Thus, they can be configured to control on-screen functions of an e-sports game being played on the electronic device 20, such as navigation, jumping, sprinting, switching screens, adjusting perspectives, and releasing skills.

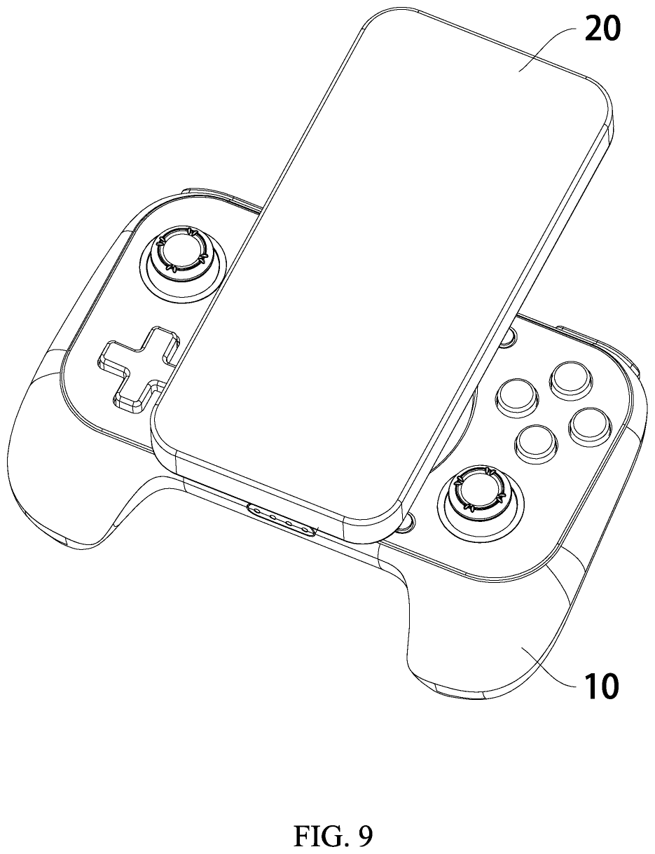

Referring to FIG. 8 and FIG. 9, in a further implementation, the gamepad housing 1 is fixedly provided with a joystick bracket 11. The joystick bracket 11 presses and fixes the control circuit board 21 to the gamepad housing 1, thereby making the connection between the control circuit board 21 and the gamepad housing 1 more stable. This ensures that the position of the control circuit board 21 remains stable when the game control input module 22 is pressed by a user. In a further implementation, the gamepad housing 1 can be provided with a battery compartment 12. A compartment body of the battery compartment 12 can be detachably connected to a battery cover 121 for closing the battery compartment 12. The battery module 23 is mounted on the battery compartment 12. Specifically, the battery cover 121 is detachably connected to the compartment body of the battery compartment 12 through a screw, making it easy for a user to replace the battery module 23. In other embodiments, the detachable connection between the battery cover 121 and the compartment body of the battery compartment 12 can also adopt other structures, such as a clamping block and clamping slot structure, and a magnetic fixing structure, to achieve the detachable connection between the battery cover 121 and the compartment body of the battery compartment 12. In a further implementation, the battery module 23 can also be directly fixedly disposed within the gamepad housing 1, that is, the battery module 23 is placed into the gamepad housing 1. The present disclosure does not limit a specific implementation.

In a further implementation, the control circuit board 21 is fixedly and electrically connected to a lighting indicator 211 and a USB charging module 212, to charge the battery module 23 and display a charging state. It can be understood that the USB charging module 212 can also have other interactive functions, such as signal transmission between the gamepad 10 and other devices through the USB charging module 212.

Referring to FIG. 9 to FIG. 11, an implementation principle of the gamepad 10 for the electronic device in this embodiment of the present disclosure is as follows: When a user needs to control an e-sports game by using the gamepad 10, the clamping link 32 rotates relative to the clamping base 31, and the clamping frame 33 rotates relative to the clamping link 32, so that the clamping assembly 3 switches from the folded state to the unfolded state. After the clamping frame 33 is unfolded to an appropriate position, the electronic device 20 is fixed to the clamping frame 33 by magnetic attraction of the permanent magnet 331, making it convenient for a user to observe the electronic device 20. After the electronic device 20 is clamped and fixed by the clamping frame 33, a distance and angle between the electronic device 20 and the gamepad housing 1 can be continued to be adjusted through the relative rotation between the clamping link 32 and the clamping base 31, and the relative rotation between the clamping frame 33 and the clamping link 32, thereby adjusting the electronic device 20 to an appropriate watching position and angle. This mitigates the following problems: After clamping the electronic device 20, the existing clamping plate can only drive the electronic device 20 to rotate around one rotation axis to adjust an observation angle of the electronic device 20. As a result, the adjustability of a distance and angle between the electronic device 20 and the gamepad housing 1 is poor. Consequently, a user cannot adjust the electronic device 20 to a proper watching position and angle, and the user experience is poor.

The above embodiments are only preferred embodiments of the present disclosure, and do not limit the protection scope of the present disclosure. Therefore, any equivalent changes made on the basis of the structure, shape, and principle of the present disclosure shall all fall within the protection scope of the present disclosure.

What is claimed is:

1. A gamepad for an electronic device, comprising a gamepad housing, a control assembly, and a clamping assembly, wherein the gamepad housing is divided into a left functional region, a middle functional region, and a right functional region; the left functional region is connected to one end of the middle functional region, and the right functional region is connected to another end of the middle functional region; the control assembly is arranged on the housing and is configured to control an e-sports game;
the clamping assembly comprises a clamping base, a clamping link, and a clamping frame; the clamping base is fixedly arranged in the middle functional region; one end of the clamping link is rotatably connected to the clamping base, and another end of the clamping link is rotatably connected to the clamping frame, to achieve unfolding and folding of the clamping assembly; the clamping frame is fixedly provided with a permanent magnet; the permanent magnet is configured to magnetically fix the electronic device; when the clamping assembly is in a folded state, the clamping link and the clamping frame are both in abutting fit with the middle functional region; and when the clamping assembly switches from the folded state to an unfolded state, at least one of the clamping link and the clamping frame rotates relative to the clamping base.

2. The gamepad for the electronic device according to claim 1, wherein a placement slot is formed in the middle functional region; and when the clamping assembly is in the folded state, the clamping frame is located in the placement slot.

3. The gamepad for the electronic device according to claim 1, wherein an abutment groove is formed in the middle functional region, and the abutment groove is configured to be in abutting fit with the clamping link and support the clamping link.

4. The gamepad for the electronic device according to claim 1, wherein the control assembly comprises a control circuit board, a game control input module, and a battery module; the control circuit board is fixedly disposed within the gamepad housing; the game control input module is fixed and electrically connected to the control circuit board; and the battery module is arranged on the gamepad housing and is electrically connected to the control circuit board.

5. The gamepad for the electronic device according to claim 4, wherein the gamepad housing is fixedly provided with a joystick bracket; and the joystick bracket presses and fixes the control circuit board to the gamepad housing.

6. The gamepad for the electronic device according to claim 4, wherein the gamepad housing is provided with a battery compartment; a compartment body of the battery compartment is detachably connected with a battery cover for closing the battery compartment; and the battery module is mounted in the battery compartment.

7. The gamepad for the electronic device according to claim 4, wherein the battery module is fixedly disposed within the gamepad housing.

8. The gamepad for the electronic device according to claim 4, wherein the control circuit board is fixed and electrically connected to a lighting indicator and a universal serial bus (USB) charging module, to charge and display the battery module.
